(19) United States
(12) Patent Application Publication
(10) Pub. No.: US 2021/0304082 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Junpei NOGUCHI, Saitama (JP); Gaku SHIMAMOTO, Saitama (JP); Yuta TAKADA, Tokyo (JP); Ryoma TAGUCHI, Tokyo (JP)

(73) Assignee: HONDA MOTOR CO., LTD., Tokyo (JP)

(21) Appl. No.: 17/215,789

(22) Filed: Mar. 29, 2021

(30) Foreign Application Priority Data
Mar. 30, 2020 (JP) 2020-061638

(51) Int. Cl. G06Q 10/02; G06Q 50/30

(52) U.S. Cl. CPC G06Q 10/02; G06Q 50/30

(57) ABSTRACT

An accommodation area management device is configured to manage an accommodation area for accommodating a moving body and includes a reservation reception unit configured to receive a use reservation related to use of the accommodation area of the moving body, and an entry determination unit configured to determine permission or non-permission of entry of the moving body into the accommodation area. The reservation reception unit is configured to acquire information on a size of the moving body when receiving the use reservation. The entry determination unit is configured to compare the size of the moving body when the moving body enters the accommodation area with the size of the moving body acquired when the use reservation is received and determine whether to permit the entry of the moving body into the accommodation area.

### CROSS-REFERENCE TO RELATED APPLICATIONS

This application is based on and claims priority under 35 USC 119 from Japanese Patent Application No. 2020-061638 filed on Mar. 30, 2020.

### TECHNICAL FIELD

The present disclosure relates to an accommodation area management device.

### BACKGROUND ART

In a related art, JP-A-H11-007600 discloses a determination device for an entering vehicle in a mechanical multi-story parking lot facility. The determination device is configured to measure and grasp a size of a vehicle before the vehicle enters the parking lot to confirm whether the vehicle can enter the parking lot.

An accommodation area management device disclosed in JP-A-H11-007600 measures the size of the vehicle to confirm whether the vehicle can enter a parking lot when the vehicle enters the parking lot in a case of a mechanical parking lot such as a pallet type or the like. The accommodation area management device does not consider a case for a self-propelled parking lot which is not the pallet type. For example, in a case of reserving a parking lot and parking a vehicle in the parking lot thereafter, when a size of the vehicle at the time of making a reservation and the size of the vehicle at the time of entering the parking lot are different from each other, a parking space where the vehicle can be parked may not be secured.

### SUMMARY

The present disclosure provides an accommodation area management device capable of preventing, in advance, a situation in which a moving body cannot travel in an accommodation area and smoothly managing the accommodation area.

According to the present disclosure, there is provided an accommodation area management device configured to manage an accommodation area for accommodating a moving body. The accommodation area management device includes a reservation reception unit configured to receive a use reservation related to use of the accommodation area of the moving body, and an entry determination unit configured to determine permission or non-permission of entry of the moving body into the accommodation area. The reservation reception unit is configured to acquire information on a size of the moving body when receiving the use reservation. The entry determination unit is configured to compare the size of the moving body when the moving body enters the accommodation area with the size of the moving body acquired when the use reservation is received and determine whether to permit the entry of the moving body into the accommodation area.

According to the above accommodation area management device, it is possible to prevent, in advance, a situation in which a moving body cannot travel in an accommodation area and to smoothly manage the accommodation area.

### BRIEF DESCRIPTION OF DRAWINGS

FIG. 1 is a diagram illustrating an example of a configuration of a vehicle system according to an embodiment:

FIG. 2 is a diagram illustrating an example of a parking lot managed by a parking lot management device according to the embodiment;

FIG. 3 is a diagram illustrating an example of a configuration of the parking lot management device according to the embodiment;

FIG. 4 is a diagram illustrating an example of a parking space status table.

FIG. 5 is a diagram illustrating a first example of a fee table;

FIG. 6 is a diagram illustrating a second example of the fee table;

FIG. 7 is a diagram illustrating a third example of the fee table; and

FIG. 8 is a flow chart of an entry determination flow.

### DESCRIPTION OF EMBODIMENTS

Hereinafter, an accommodation area management device according to an embodiment of the present disclosure will be described with reference to the accompanying drawings. In the following embodiment, a vehicle is an example of a moving body and a parking lot is an example of an accommodation area. Further, in the following embodiment, a parking lot management device for managing a parking lot is an example of an accommodation area management device.

[Vehicle System]

First, a vehicle of the embodiment (hereinafter, also referred to as a vehicle M) will be described.

The vehicle of the embodiment (hereinafter, also referred to as the vehicle M) is an automobile including a drive source (for example, a traveling driving force output device 200 which will be described later) and wheels (for example, two wheels, three wheels, or four wheels) including a drive wheel driven by the power of the drive source. As the drive source of the vehicle M, for example, there are an electric motor, an internal combustion engine (for example, a gasoline engine), or a combination of the electric motor and the internal combustion engine.

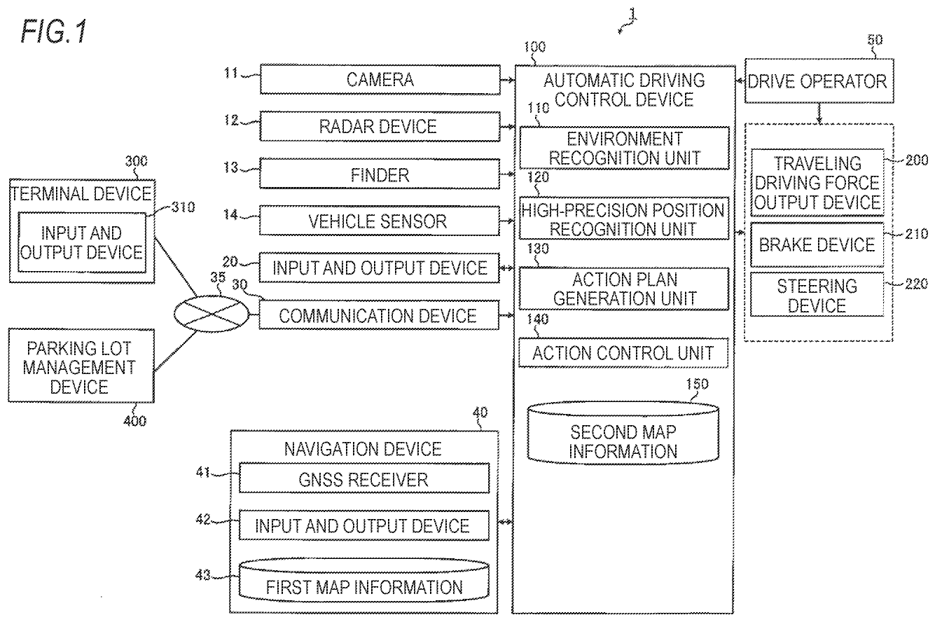

Further, the vehicle M includes a vehicle system 1 illustrated in FIG. 1. The vehicle system 1 has a function capable of performing all driving tasks related to the vehicle M at least in a limited specific area (for example, in a parking lot PA which will be described later). Here, the driving task is, for example, a real-time driving function required for operating the vehicle M, such as controlling the movement of the vehicle M in the left-right direction (steering), controlling the movement in the front-rear direction (acceleration and deceleration), monitoring the driving environment or the like, and a tactical function such as planning of a traveling track or the like.

As illustrated in FIG. 1, the vehicle system 1 includes a camera 11, a radar device 12, a finder 13, a vehicle sensor 14, an input and output device 20, a communication device 30, a navigation device 40, a driving operator 50, an automatic driving control device 100, a traveling driving force output device 200, a brake device 210, and a steering device 220. The respective devices are communicably connected to each other via a wired or wireless communication network. The communication network connecting the respective devices is, for example, a Controller Area Network (CAN).

The camera 11 is a digital camera which images the periphery of the vehicle M (for example, in front of the vehicle M), and outputs the image data obtained by imaging the periphery thereof to the automatic driving control device 100. The radar device 12 is, for example, a radar device using radio waves in a millimeter wave band, detects a position of an object in the periphery of the vehicle M (for example, the front, the rear, and the side of the vehicle M), and outputs the detection result to the automatic driving control device 100.

The finder 13 is, for example, Laser Imaging Detection and Ranging (LIDAR), uses a predetermined laser beam to measure a distance to the object (a target object) existing in the periphery of the vehicle M (for example, the front, the rear, and the side of the vehicle M), and outputs a measurement result of the distance to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around the vertical axis of the vehicle M, and an orientation sensor which detects the direction of the vehicle M, or the like. Further, the vehicle sensor 14 includes a radio wave intensity sensor which detects the radio wave intensity (that is, a communication intensity) of radio waves used for communication by the communication device 30. The vehicle sensor 14 outputs the detection result of each sensor to the automatic driving control device 100.

The input and output device 20 includes an output device which outputs various information to a user of the vehicle M, and an input device which receives various input operations from the user of the vehicle M (hereinafter, also simply referred to as a user). In the embodiment, the user is not limited to a person who manages or owns the vehicle M and uses the vehicle M. For example, the user may be a person who uses the vehicle M on behalf of the person who manages or owns the vehicle M at the request of the person who manages or owns the vehicle M. The output device of the input and output device 20 is, for example, a display which performs displaying based on the processing result of the automatic driving control device 100. The output device may be a speaker, a buzzer, an indicator light, or the like. Further, the input device of the input and output device 20 is, for example, a touch panel or an operation button (a key, a switch, or the like) which outputs an operation signal corresponding to the input operation received from the user to the automatic driving control device 100.

The communication device 30 is wirelessly connected to a network 35 and communicates with another device provided outside the vehicle system 1 via the network 35. The network 35 is, for example, a mobile communication network, a Wi-Fi network, Bluetooth (registered trademark), Dedicated Short Range Communication (DSRC), or the like.

The communication device 30 communicates with, for example, a terminal device 300 carried by the user and a parking lot management device 400 which manages a parking lot PA in which the vehicle M can be parked. The terminal device 300 is, for example, a smartphone, a tablet terminal, or the like, and is an electronic device connected to the network 35 and including an input and output device 310. The input and output device 310 is, for example, a display, which displays various information to the user, a touch panel, which receives the input operation of the user, or the like. The parking lot PA and the parking lot management device 400 will be described later.

The navigation device 40 includes a Global Navigation Satellite System (GNSS) receiver 41 and an input and output device 42. Further, the navigation device 40 includes a storage device (not illustrated) such as a hard disk drive (hereinafter, also referred to as an HDD), a flash memory, or the like, and first map information 43 is stored in the storage device. The first map information 43 is, for example, information representing a road shape by a link indicating a road and a node connected by the link. Further, the first map information 43 may include information representing the curvature of the road and a Point Of Interest (POI).

The GNSS receiver 41 specifies the latitude and longitude of a point where the vehicle M is positioned as the position of the vehicle M based on the signal received from a GNSS satellite. Further, the navigation device 40 may specify or correct the position of the vehicle M by an Inertial Navigation System (INS) using the output of the vehicle sensor 14.

The input and output device 42 includes an output device, which outputs various information to the user and an input device, which receives various input operations from the user. The output device of the input and output device 42 is, for example, a display which performs displaying based on the processing result of the navigation device 40 (for example, displays a route on the map, which will be described later). Further, the input device of the input and output device 42 is, for example, a touch panel or an operation button (a key, a switch, or the like) which outputs the operation signal corresponding to the input operation received from the user to the navigation device 40. The input and output device 42 may be shared with the input and output device 20.

Although the detailed description is omitted, for example, the navigation device 40 determines a route from the position of the vehicle M specified by the GNSS receiver 41 to the destination inputted by the user (hereinafter, also referred to as the route on the map) with reference to the first map information 43. Next, the navigation device 40 guides the determined route on the map to the user by the input and output device 42. Further, the navigation device 40 is configured to output information indicating the position of the vehicle M specified by the GNSS receiver 41 and information indicating the determined route on the map to the automatic driving control device 100.

Further, a part or all of the functions of the navigation device 40 may be realized by the function of the terminal device 300. Further, a part or all of the functions of the navigation device 40 may be realized by an external server device (a navigation server) capable of communicating with the vehicle system 1 by the communication device 30 or the like.

The driving operator 50 is various operators such as an accelerator pedal, a brake pedal, a shift lever, a steering wheel, a variant steering wheel, a joystick, and the like. The driving operator 50 is provided with a sensor, which detects the amount of the operation or the presence or absence of operation on the driving operator 50. The detection result by the sensor of the driving operator 50 is outputted to a part or all of the automatic driving control device 100, the traveling driving force output device 200, the brake device 210, and the steering device 220.

The traveling driving force output device 200 outputs the traveling driving force (torque) for the vehicle M to travel to the drive wheel. The traveling driving force output device 200 includes, for example, an electric motor and an electric motor Electronic Control Unit (ECU) which controls the electric motor. The electric motor ECU controls the electric motor based on the detection result by the sensor of the driving operator 50 (for example, the accelerator pedal) and control information from the automatic driving control device 100. Further, when the vehicle M includes an internal combustion engine and a transmission as a drive source, the traveling driving force output device 200 may include the internal combustion engine, the transmission, and the ECU which controls the internal combustion engine and the transmission.

The brake device 210 includes, for example, a brake caliper, a cylinder which transmits hydraulic pressure to the brake caliper, an electric motor which generates the hydraulic pressure in the cylinder, and a brake ECU. The brake ECU controls the electric motor of the brake device 210 based on the detection result by the sensor of the driving operator 50 (for example, the brake pedal) and the control information from the automatic driving control device 100, and outputs the brake torque in accordance with a brake operation to each wheel.

The steering device 220 includes, for example, a steering ECU and an electric motor. The electric motor of the steering device 220 changes the direction of the steering wheel by, for example, applying a force to a rack and pinion mechanism. The steering ECU drives the electric motor of the steering device 220 based on the detection result by the sensor of the driving operator 50 (for example, the steering wheel) and the control information from the automatic driving control device 100, and changes the direction of the steering wheel (that is, a steering angle).

[Automatic Driving Control Device]

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like accessible to each functional unit (for example, the high-precision position recognition unit 120) of the automatic driving control device 100, and second map information 150 is stored in the storage device.

The second map information 150 is more accurate map information than the first map information 43. The second map information 150 includes, for example, information indicating the center of a lane, information indicating a lane boundary line (for example, a road lane marking), and the like. The second map information 150 may include road information, traffic regulation information, address information, facility information, telephone number information, and the like.

Further, the second map information 150 may be updated at any time when the communication device 30 communicates with another device. For example, when the vehicle M enters the parking lot PA, the communication device 30 receives information indicating the lanes in the parking lot PA, the position of each parking space, and the like (hereinafter, also referred to as map information in the parking lot) from the parking lot management device 400. Next, the automatic driving control device 100 updates the second map information 150 to incorporate the received map information in the parking lot into the second map information 150. As a result, the automatic driving control device 100 can specify the position of each parking space in the parking lot PA, or the like with reference to the second map information 150. Further, the second map information 150 may be updated when the communication device 30 communicates with a server which distributes the map information or the like.

The environment recognition unit 110 performs sensor fusion processing on the information to be acquired by a part or all of the camera 11, the radar device 12, and the finder 13, recognizes an object existing in the periphery of the vehicle M and also recognizes the position of the object. The environment recognition unit 110 recognizes, for example, obstacles, road shapes, traffic lights, guardrails, utility poles, surrounding vehicles (including the traveling status such as the speed, acceleration, and the like, and parking state), lane marks, pedestrians, or the like, and also recognizes positions thereof.

The high-precision position recognition unit 120 recognizes the detailed position and posture of the vehicle M with reference to the position of the vehicle M specified by the navigation device 40, the detection result by the vehicle sensor 14, the image captured by the camera 11, the second map information, or the like. The high-precision position recognition unit 120 recognizes, for example, the traveling lane on which the vehicle M is traveling, or recognizes a relative position and a posture of the own vehicle with respect to the traveling lane. The high-precision position recognition unit 120 also recognizes, for example, the position of the vehicle M in the parking lot PA, or the like.

The action plan generation unit 130 generates an action plan of the vehicle M. Specifically, the action plan generation unit 130 generates a target track on which the vehicle M will travel in the future as an action plan of the vehicle M. For example, the target track is information represented by arranging points (track points) to be reached by the vehicle M for each predetermined traveling distance (for example, about several [m]). Further, the target track may include information on speed elements such as the target speed, the target acceleration, and the like of the vehicle M at each predetermined time or at each track point. The action plan generation unit 130 generates the action plan, for example, according to an instruction of the parking lot management device 400 received by the communication device 30.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track, or controls the steering device 220 according to a curvature degree of the target trajectory.

Each functional unit provided in the automatic driving control device 100 is realized, for example, by a central processing unit (CPU) executing a predetermined program (software). A part or all of the functional units of the automatic driving control device 100 may be realized by hardware such as Large Scale Integration (LSI), an Application Specific Integrated Circuit (ASIC), a Field-Programmable Gate Array (FPGA), and a Graphics Processing Unit (GPU), or the like, and for example, the storage device for storing the second map information 150 and the high-precision position recognition unit 120 may be realized by a Map Positioning Unit (MPU). A part or all of the functional units of the automatic driving control device 100 may be realized by the cooperation of the software and the hardware.

[Parking Lot Managed by Parking Lot Management Device]

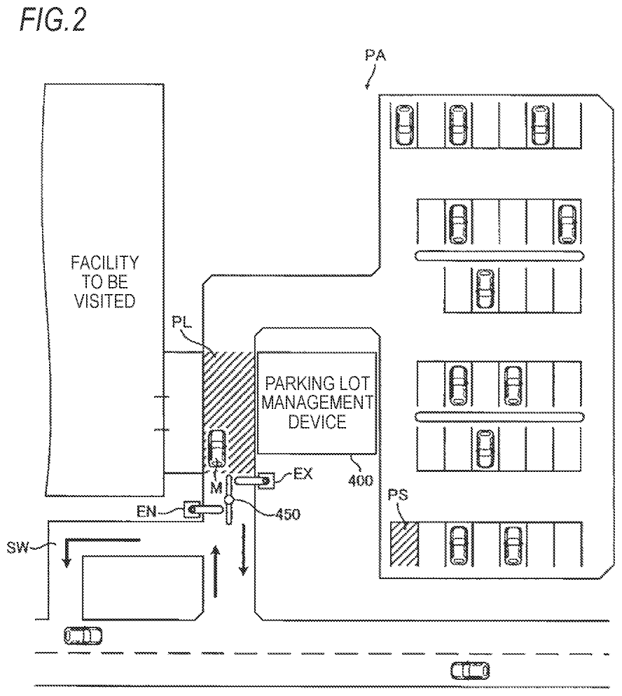

Next, an example of the parking lot PA will be described with reference to FIG. 2. As illustrated in FIG. 2, the parking lot PA is a parking lot managed by the parking lot management device 400 and is an automatic valet parking type parking lot provided as an annex in a visiting facility to be visited by a user. The parking lot PA includes a plurality of parking spaces PS capable of accommodating a vehicle (for example, the vehicle M) and a boarding area PL provided in front of the plurality of parking spaces PS.

Further, an entrance gate EN which the vehicle passes through when entering the parking lot PA, and an exit gate EX which the vehicle passes through when exiting from the parking lot PA are provided in front of the boarding area PL of the parking lot PA. The vehicle entering the entrance gate EN and the vehicle exiting from the exit gate EX are monitored by an imaging device 450 at the entrance gate EN and the exit gate EX. The imaging device 450 is, for example, a digital camera or a digital video using a solid-state imaging element such as a CCD, a CMOS, and the like, and periodically transmits a captured image or a captured video to the parking lot management device 400. The image or video periodically transmitted by the imaging device 450 can be used as information for detecting the size of the moving body when the moving body enters the accommodation area.

Hereinafter, an example in which the user of the vehicle M uses the parking lot PA will be described.

Before using the parking lot PA, the user of the vehicle M makes a reservation for using the parking lot PA to the parking lot management device 400 which manages the parking lot PA by using the terminal device 300. For example, the user of the vehicle M inputs a date and time of using the parking lot PA and identification information of the vehicle M into the terminal device 300 and transmits these pieces of information to the parking lot management device 400, thereby making a reservation for using the parking lot PA. After that, when the date and time of the reservation therefor are reached, the user of the vehicle M drives the vehicle M to the boarding area PL through the entrance gate EN, and gets off from the vehicle M at the boarding area PL.

After the user gets off the vehicle M, the vehicle M performs automatic driving and starts a self-propelled entry event to move the vehicle M to the parking space PS in the parking lot PA. For example, the user transmits a request for starting the self-propelled entry event to the parking lot management device 400 by using the terminal device 300. In response to the request, the parking lot management device 400 instructs the vehicle M to perform the self-propelled entry event for permitting the vehicle M to be parked in a predetermined parking space PS. According to this instruction, the vehicle M moves to the parking space PS instructed by the parking lot management device 400 while being guided by the parking lot management device 400 and performing sensing by the camera 11, the radar device 12 or the finder 13 or the like.

Further, when the vehicle M exits, the vehicle M performs the automatic driving and performs a self-propelled exit event to move the vehicle M from the parking space PS to the boarding area PL. For example, the user transmits a request for starting the self-propelled exit event to the parking lot management device 400 by using the terminal device 300. In response to the request, the parking lot management device 400 instructs the vehicle M to perform the self-propelled exit event to move the vehicle M from the parking space PS where the vehicle M is parked to the boarding area PL. According to this instruction, the vehicle M moves to the boarding area PL while being guided by the parking lot management device 400 and performing sensing by the camera 11, the radar device 12, the finder 13, or the like. The user of the vehicle M gets on the vehicle M at the boarding area PL and exits from the parking lot PA through the exit gate EX.

[Parking Lot Management Device]

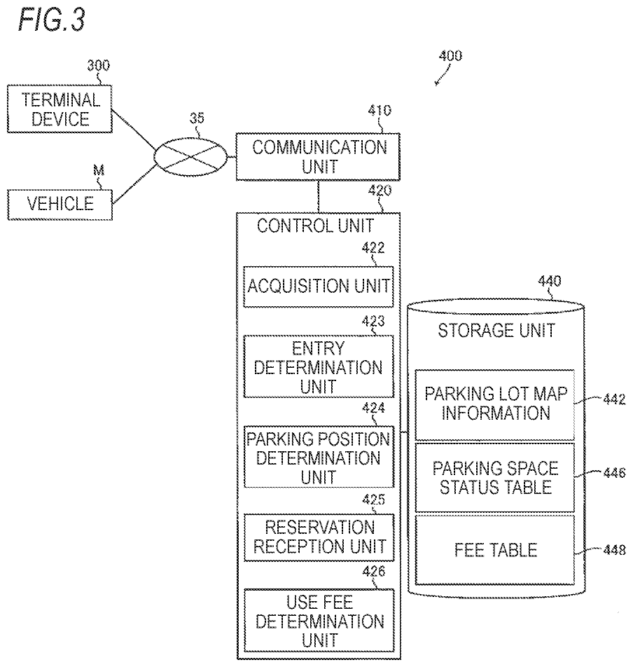

Next, an example of a configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 422, an entry determination unit 423, a parking position determination unit 424, a reservation reception unit 425, and a use fee determination unit 426. Each component of the control unit 420 may be realized, for example, by a hardware processor such as a CPU executing a program (software). Apart or all of these components may be realized by hardware such as LSI, an ASIC, an FPGA, a GPU, and the like (including a circuit unit; circuitry), or may be realized by the cooperation of the software and the hardware. The program may be stored in advance in a storage device, such as an HDD, a flash memory, and the like (a storage device including a non-transient storage medium), may be stored in a removable storage medium (the non-transient storage medium) such as a DVD, a CD-ROM, or the like and may be installed by attaching the storage medium to a drive device, and may be a program managed by another server and executed.

Information such as parking lot map information 442, a parking space state table 446, a fee table 448, or the like is stored in the storage unit 440. The storage unit 440 is realized by an HDD, a flash memory, or the like.

The communication unit 410 wirelessly (for example, the network 35) communicates with the vehicle M or the terminal device 300 of the user. The control unit 420 guides the vehicle M to the parking space PS based on the information acquired via the communication unit 410 and the information stored in the storage unit 440. The parking lot map information 442 is information which geometrically represents a structure of the parking lot PA. Further, the parking lot map information 442 includes coordinates for each parking space PS.

The reservation reception unit 425 receives a use reservation regarding the use of the parking lot PA of the vehicle M via the communication unit 410. When receiving the use reservation, the reservation reception unit 425 acquires information on the size of the vehicle M (hereinafter, may be referred to as vehicle information) in addition to scheduled entry time to be used and the identification information of the vehicle M. The identification information of the vehicle M is, for example, a vehicle number of a vehicle number plate (so-called a license plate), a chassis number, or the like. Further, the reservation reception unit 425 is not necessarily limited to acquiring the vehicle information from the vehicle M or the terminal device 300 of the user but may receive the use reservation from another device.

For example, the information on the size of the vehicle M (vehicle information) may be, for example, information including the total length and the vehicle width, or may be information including the total length, the vehicle width, and the vehicle height. Further, the vehicle information may be a type of the vehicle M which is information for deriving the size of the vehicle M. The type of vehicle M may be separately represented such as a full-sized vehicle, a medium-sized vehicle, a compact vehicle, or the like.

The vehicle information includes the information on the size of a load when the vehicle M loads the load. In this case, the vehicle information may be the respective sizes of the vehicle M and the load, or may be the total size of the vehicle M loaded with the load. Examples of the load include a storage box, a carrier, a bag, a ski, a snowboard, or the like fixed to the roof.

When the vehicle M tows a towed vehicle, the vehicle information includes information related to the size of the towed vehicle. In this case, the vehicle information may be the respective sizes of the vehicle M and the towed vehicle, or may be the total size of the vehicle M towing the towed vehicle. Examples of the towed vehicle include a trailer, a container, a loading platform, a passenger car, or the like.

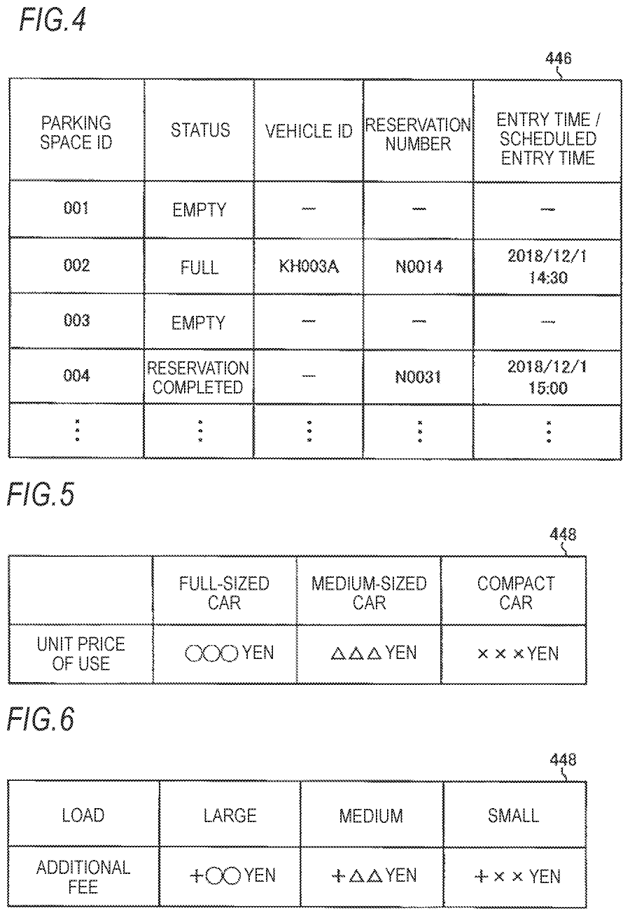

The acquisition unit 422 acquires parking space information of the vehicle M already being parked in the parking lot PA and parking space information of the vehicle M already being reserved for use in the parking lot PA via the communication unit 410. The parking space information is stored, for example, in the form of the parking space status table 446. As illustrated in FIG. 4, the parking space status table 446 includes: for example, information indicating whether a parking space ID, which is identification information of the parking space PS, is in a vacant status, a full (parked) status, or a reserved status; a vehicle ID which is the identification information of the parked vehicle M when the parking space ID is in the full status; the entry time of the vehicle M when the parking space ID is in the full status; a reservation number when the parking space ID is in the reserved status; and the scheduled entry time when the parking space ID is in the reserved status. The entry time is recorded in association with the vehicle ID of the vehicle M when the vehicle M enters the parking space PS. The scheduled entry time is recorded in association with the reservation number at the time of making a reservation.

The parking position determination unit 424 determines the parking position of the vehicle M based on the information acquired by the reservation reception unit 425 and the parking space information acquired by the acquisition unit 422. As described above, the information acquired by the reservation reception unit 425 includes the scheduled entry time, the vehicle information, the identification information of the vehicle M, or the like. The reservation reception unit 425 acquires the vehicle information related to the size of the vehicle M when receiving the use reservation and the parking position determination unit 424 can secure the parking space PS matching the vehicle information in advance, thereby making it possible to smoothly manage the parking lot PA.

When the vehicle M enters the parking lot PA, the entry determination unit 423 determines whether the vehicle M is permitted to enter the parking lot PA based on the vehicle information. More specifically, the entry determination unit 423 acquires the size of the vehicle M when the vehicle M enters the parking lot PA, and compares the size of the vehicle M when the vehicle M enters the parking lot PA with the size of the vehicle M acquired by the reservation reception unit 425. Next, if the size of the vehicle M when the vehicle M enters the parking lot PA is equal to or smaller than the size of the vehicle M acquired by the reservation reception unit 425, the vehicle M is permitted to enter the parking lot PA. On the other hand, if the size of the vehicle M when the vehicle M enters the parking lot PA is larger than the size of the vehicle M acquired by the reservation reception unit 425, the vehicle M is not permitted to enter the parking lot PA.

In this manner, the size of the vehicle M is confirmed when the vehicle M enters the parking lot PA, which makes it possible to prevent, in advance, a situation in which the vehicle M cannot travel in the parking lot PA because the size of the vehicle M when the vehicle M enters is larger than the size thereof at the time of receiving the reservation.

The entry determination unit 423 may acquire the size of the vehicle M when the vehicle M enters the parking lot PA from the imaging device 450 provided at the entrance gate EN, or may request the user of the vehicle M to input the size of the vehicle M when the vehicle M enters the parking lot PA. For example, when the user of the vehicle M inputs the size of the vehicle M, the entry determination unit 423 may allow the user to input the size thereof by using the input device provided at the entrance gate EN or may acquire the size thereof from the vehicle M or the terminal device 300 of the user of the vehicle M via the communication unit 410 when the vehicle M passes through the entrance gate EN.

Even if the size of the vehicle M when the vehicle M enters the parking lot PA is larger than the size of the vehicle M acquired by the reservation reception unit 425, the entry determination unit 423 may permit the vehicle M to enter the parking lot PA when there is a parking space PS capable of accommodating the vehicle M. That is, if the size of the vehicle M acquired when the vehicle enters the parking lot PA is larger than the size thereof acquired at the time of receiving the reservation, the entry determination unit 423 confirms whether there is the parking space PS capable of accommodating the vehicle M at the time of the entry of the vehicle M. Next, when there is the parking space PS capable of accommodating the vehicle M, the entry of the vehicle M can be permitted. As a result, it is possible to promote the efficient use of the parking lot PA while preventing, in advance, the occurrence of a trouble in which it is found out that there is no parking space PS after the vehicle M enters the parking lot PA.

On the other hand, if the size of the vehicle M when the vehicle M enters the parking lot PA is larger than the size of the vehicle M acquired by the reservation reception unit 425, and there is no parking space PS capable of accommodating the vehicle M, the entry determination unit 423 does not permit the vehicle M to enter the parking lot PA. As described above, when there is no parking space PS capable of accommodating the vehicle M, the vehicle M is not permitted to enter the parking lot PA and the parking lot management device 400 can prevent the vehicle M that cannot be accommodated therein from entering the parking lot PA, and can prevent, in advance, the situation in which the vehicle M cannot travel in the parking lot PA.

When the vehicle M is not permitted to enter the parking lot PA, it is desirable that the entry determination unit 423 provides the user of the vehicle M with parking lot information on another parking lot including the parking space PS capable of accommodating the vehicle M. The parking lot information desirably includes a parking lot closest to the parking lot PA, and when there are a plurality of parking lots in the periphery of the parking lot PA, it is desirable to provide the user of the vehicle M with parking lot information on the plurality of parking lots. As a result, the user can accommodate the vehicle M in another parking lot PA. Further, the parking lot management device 400 can increase a use opportunity of another parking lot PA.

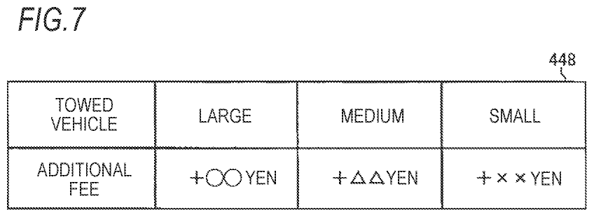

The use fee determination unit 426 determines a use fee of the parking lot PA. For example, the use fee is determined based on a unit price of use set based on the size of the vehicle M. As illustrated in FIG. 5, the unit price of use may be stored in the form of the fee table 448 in association with the vehicle information, or may be calculated based on a predetermined calculation formula. FIG. 6 illustrates the fee table 448 in which the load and an additional fee are associated with each other, and FIG. 7 illustrates the fee table 448 in which the towed vehicle and the additional fee are associated with each other. The presence or absence of the load and/or the towed vehicle may be in the form of the additional fee as illustrated in FIGS. 6 and 7, or may be included in the unit price of use.

If the size of the vehicle M when the vehicle M enters the parking lot PA is equal to or smaller than the size of the vehicle M acquired by the reservation reception unit 425, the use fee determination unit 426 determines the unit price of use set based on the size of the vehicle M acquired by the reservation reception unit 425 as a confirmed unit price. As a result, the unit price of use can be easily acquired.

On the other hand, if the size of the vehicle M when the vehicle M enters the parking lot PA is larger than the size of the vehicle M acquired by the reservation reception unit 425, the use fee determination unit 426 determines a fee that is equal to or greater than the unit price of use set based on the size of the vehicle M acquired by the reservation reception unit 425 as a confirmed unit price. That is, the use fee determination unit 426 can determine the unit price of use set based on the size of the vehicle M when the vehicle M enters the parking lot PA as the confirmed unit price. Since the size of the vehicle M, which is the basis for calculating the unit price of use, is larger than the size of the vehicle M acquired by the reservation reception unit 425, the confirmed unit price is equal to or greater than the unit price of use set based on the size of the vehicle M acquired by the reservation reception unit 425 and is not basically lower than the unit price of use set based on the size of the vehicle M acquired by the reservation reception unit 425. Accordingly, appropriate use of the parking lot PA can be promoted.

If the size of the vehicle M when the vehicle M enters the parking lot PA is larger than the size of the vehicle M acquired by the reservation reception unit 425, the unit price of use set based on the size of the vehicle M when the vehicle M enters the parking lot PA may be the same as the unit price of use set based on the size of the vehicle M acquired by the reservation reception unit 425, or may be greater or the same, or may be changed depending on a situation.

For example, the use fee determination unit 426 determines the use fee by multiplying the unit price of use set based on the size of the vehicle M acquired by the reservation reception unit 425, or the unit price of use set based on the size of the vehicle M when the vehicle M enters the parking lot PA by use time, and by further adding the additional fee in accordance with the presence or absence of the load and/or the towed vehicle, and the size of the load and/or the towed vehicle. Further, the use fee determination unit 426 may also determine the use fee by giving a point for each item and by multiplying a total point by a predetermined point unit price.

It is desirable that the use fee determination unit 426 provides the user with the confirmed unit price when the vehicle M enters the parking lot PA. Even though the unit price of use is set based on the size of the vehicle M acquired by the reservation reception unit 425 and even though the unit price of use is set based on the size of the vehicle M when the vehicle M enters the parking lot PA, the user can know the unit price of use when entering the parking lot PA and the convenience of the parking lot PA is improved.

In addition to the vehicle information described above, the use fee determination unit 426 may change the use fee depending on a parking time zone (early morning, midnight, daytime, or the like), a congestion situation of the parking lot PA (when the parking lot PA is congested, and when parking lot PA is not congested), or the like. The use fee determination unit 426 can collect the use fee in accordance with a load of the parking lot management device 400 by changing the use fee based on a use situation of the parking lot PA. Further, the use fee changes based on the use situation of the parking lot PA, thereby making it possible to attract a user and improve the operating rate of the parking lot PA.

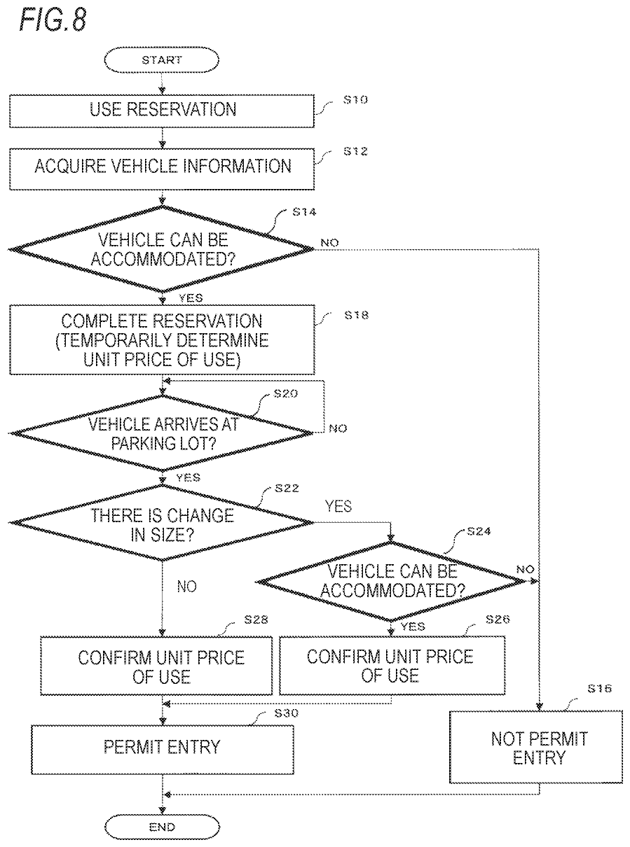

Next, an entry determination flow of the parking lot management device 400 will be described with reference to FIG. 8.

First, a user makes a use reservation of the parking lot PA (S10). The reservation reception unit 425 acquires the vehicle information, which is the information on the size of the vehicle M of the user, at the time of receiving the use reservation thereof (S12). The parking position determination unit 424 determines whether the vehicle M can be parked at a designated date and time based on the vehicle information acquired by the reservation reception unit 425 (S14). As a result, when the vehicle M cannot be parked at the designated date and time, the reservation reception unit 425 notifies that the vehicle cannot enter the parking lot PA (S16).

As a result of step S14, when the vehicle M can be parked at the designated date and time, the use fee determination unit 426 temporarily determines the unit price of use based on the size of the vehicle M from, for example, the fee table or the like of FIG. 5 and completes the reservation (S18). When the vehicle M arrives at the parking lot PA (S20), the entry determination unit 423 acquires the size of the vehicle M when the vehicle M enters the parking lot PA and determines whether there is a change in the size of the vehicle M (S22). As a result, when there is no change in the size of the vehicle M, the temporarily determined unit price of use at the time of reservation completion is determined as the confirmed unit price of use (S28), and the vehicle M is permitted to enter the parking lot PA (S30). The confirmed unit price of use indicates the unit price of use which is confirmed.

On the other hand, when there is a change in the size of the vehicle M, the entry determination unit 423 determines whether the vehicle M can be parked at the current time based on the vehicle information acquired this time (S24). As a result, when the vehicle M cannot be parked at the current time, the vehicle M is not permitted to enter the parking lot PA. At this time, the vehicle M can return to an original road from a branch road SW provided in front of the entrance gate EN. Further, in this case, it is desirable that the entry determination unit 423 provides parking lot information on another parking lot including the parking space PS capable of accommodating the vehicle M.

As a result of step S24, when the vehicle M can be parked at the current time, the entry determination unit 423 confirms the unit price of use based on the size of the vehicle M acquired this time as the confirmed unit price of use (S26) and permits the vehicle M to enter the parking lot PA (S30).

The embodiment describes a case in which a so-called vehicle is parked in a parking lot. However, the inventive concept of the present invention is not limited to such an embodiment and is also applied to a moving body including a vehicle (for example, a robot). That is, the present disclosure also includes a case where the moving body is accommodated in an accommodation area where the moving body can be accommodated. In consideration of this idea, “parking” is extended to a concept of “stop”, and the “parking lot management device” of the embodiment is extended to a concept of the “accommodation area management device”. “Exit” and “entry” are extended to concepts of “leaving” and “approaching”.

While a mode for implementing the present invention is described above by using the embodiment, inventive concept of the present invention is not limited to the embodiment, and various modifications and substitutions can be added within the scope not departing from the gist of the present invention.

Further, at least the following items are described in this specification. Components or the like corresponding to the above-described embodiments are shown in parentheses, but the present disclosure is not limited thereto.

(1) An accommodation area management device (parking lot management device 400) configured to manage an accommodation area (parking lot PA) for accommodating a moving body (vehicle M), the accommodation area management device includes:

a reservation reception unit (reservation reception unit 425) configured to receive a use reservation related to use of the accommodation area of the moving body; and

an entry determination unit (entry determination unit 423) configured to determine permission or non-permission of entry of the moving body into the accommodation area, wherein:

the reservation reception unit is configured to acquire information on a size of the moving body (vehicle information) when receiving the use reservation; and

the entry determination unit is configured to compare the size of the moving body when the moving body enters the accommodation area with the size of the moving body acquired when the use reservation is received and determine whether to permit the entry of the moving body into the accommodation area.

According to the accommodation area management device of (1), the size of the moving body acquired when the moving body enters the accommodation area is compared with the size of the moving body acquired when the use reservation is received, and whether to permit the entry of the moving body into the accommodation area is determined, thereby making it possible to prevent, in advance, a situation in which the moving body cannot travel in the accommodation area.

Further, since the accommodation area management device can acquire information on the size of the moving body at the time of receiving the reservation, the accommodation area management device can secure, in advance, an accommodation position satisfying the condition of the moving body, and the accommodation area can be smoothly managed.

(2) In the accommodation area management device according to (1),

if the size of the moving body when the moving body enters the accommodation area is equal to or smaller than the size of the moving body acquired by the reservation reception unit, the entry determination unit is configured to permit the moving body to enter the accommodation area.

According to the accommodation area management device of (2), if the size of the moving body acquired when the moving body enters the accommodation area is equal to or smaller than the size thereof acquired at the time of receiving the reservation before the moving body enters the accommodation area, the moving body is permitted to enter the management area, thereby making it possible to prevent, in advance, the situation in which the moving body cannot travel in the accommodation area.

(3) The accommodation area management device according to (2), further includes:

a use fee determination unit (use fee determination unit 426) configured to determine a use fee of the accommodation area, wherein:

the use fee determination unit is configured to acquire a unit price of use based on the size of the moving body acquired by the reservation reception unit; and

the use fee determination unit is configured to determine the unit price of use as a confirmed unit price if the size of the moving body when the moving body enters the accommodation area is equal to or smaller than the size of the moving body acquired by the reservation reception unit.

According to the accommodation area management device of (3), if the size of the moving body acquired when the moving body enters the accommodation area is equal to or smaller than the size thereof acquired at the time of receiving the reservation before the moving body enters the accommodation area, the unit price of use acquired at the time of receiving the reservation is determined as the confirmed unit price, thereby making it possible to easily acquire the unit price of use.

(4) In the accommodation area management device according to any one of (1) to (3),

if the size of the moving body w % ben the moving body enters the accommodation area is larger than the size of the moving body acquired by the reservation reception unit, the entry determination unit is configured to permit the moving body to enter the accommodation area under a condition that there is an accommodation position capable of accommodating the moving body.

According to the accommodation area management device of (4), if the size of the moving body acquired when the moving body enters the accommodation area is larger than the size thereof acquired at the time of receiving the reservation before the moving body enters the accommodation area, the entry determination unit confirms whether there is an accommodation position capable of accommodating the moving body when the moving body enters, and when there is the accommodation position, the entry determination unit is configured to permit the moving body to enter. As a result, the accommodation area can be efficiently operated while preventing, in advance, the occurrence of a trouble in which it turns out that there is no accommodation position after the moving body enters the accommodation area.

(5) The accommodation area management device according to (4), further includes:

a use fee determination unit (use fee determination unit 426) configured to determine a use fee of the accommodation area, wherein:

the use fee determination unit is configured to acquire a unit price of use based on the size of the moving body acquired by the reservation reception unit; and

the use fee determination unit is configured to determine a fee equal to or greater than the unit price of use as a confirmed unit price if the size of the moving body when the moving body enters the accommodation area is larger than the size of the moving body acquired by the reservation reception unit.

According to the accommodation area management device of (5), if the size of the moving body acquired when the moving body enters the accommodation area is larger than the size thereof acquired at the time of receiving the reservation before the moving body enters the accommodation area, the fee equal to or greater than the unit price of use acquired at the time of receiving the reservation is determined as the confirmed unit price, thereby making it possible to promote the appropriate use of the management area.

(6) The accommodation area management device according to any one of (1) to (5), further includes:

a use fee determination unit configured to determine a use fee of the accommodation area, wherein:

the entry determination unit is configured to request a user of the moving body to input the size of the moving body when the moving body enters the accommodation area, and

the use fee determination unit is configured to provide the user with the unit price of use acquired based on the size of the moving body.

According to the accommodation area management device (6), the user can know the unit price of use when entering the accommodation area, and thus, the convenience of the accommodation area is improved.

(7) In the accommodation area management device according to any one of (1) to (6),

if the size of the moving body when the moving body enters the accommodation area is larger than the size of the moving body acquired by the reservation reception unit, and there is no accommodation position capable of accommodating the moving body, the entry determination unit does not permit the moving body to enter the accommodation area.

According to the accommodation area management device of (7), if the size of the moving body acquired when the moving body enters the accommodation area is larger than the size thereof acquired at the time of receiving the reservation before the moving body enters the accommodation area, and there is no accommodation position capable of accommodating the moving body, the moving body is not permitted to enter the accommodation area, and therefore, it is possible to prevent the moving body which cannot be accommodated therein from entering the accommodation area, and to prevent, in advance, the situation in which the moving body cannot travel in the accommodation area.

(8) In the accommodation area management device according to (7),

when the moving body is not permitted to enter the accommodation area, the entry determination unit is configured to provide a user of the moving body with accommodation area information on another accommodation area including an accommodation position capable of accommodating the moving body.

According to the accommodation area management device of (8), when the moving body is not permitted to enter the accommodation area, the accommodation area information on another accommodation area including an accommodation position capable of accommodating the moving body is provided to the user, which can cause the user to accommodate the moving body in the another accommodation area. Further, the accommodation area management device can increase the use opportunity of another accommodation area.

(9) In the accommodation area management device according to any one of (1) to (8),

the accommodation area includes a boarding area (boarding area PL) for allowing the user of the moving body to get on and off; and

the accommodation area is an automatic valet parking type accommodation area where the moving body is automatically driven at least between the boarding area and the accommodation position for accommodating the moving body.

According to the accommodation area management device of (9), since the accommodation area management device is required to control the exit and entry of the moving body in the automatic valet parking type accommodation area, it is possible to avoid, in advance, confusion caused by permitting the moving body which cannot be accommodated therein to enter the accommodation area.

1. An accommodation area management device configured to manage an accommodation area for accommodating a moving body, the accommodation area management device comprising:
a reservation reception unit configured to receive a use reservation related to use of the accommodation area of the moving body; and
an entry determination unit configured to determine permission or non-permission of entry of the moving body into the accommodation area, wherein:
the reservation reception unit is configured to acquire information on a size of the moving body when receiving the use reservation; and
the entry determination unit is configured to compare the size of the moving body when the moving body enters the accommodation area with the size of the moving body acquired when the use reservation is received and determine whether to permit the entry of the moving body into the accommodation area.

2. The accommodation area management device according to claim 1, wherein
if the size of the moving body when the moving body enters the accommodation area is equal to or smaller than the size of the moving body acquired by the reservation reception unit, the entry determination unit is configured to permit the moving body to enter the accommodation area.

3. The accommodation area management device according to claim 2, further comprising:
a use fee determination unit configured to determine a use fee of the accommodation area, wherein:
the use fee determination unit is configured to acquire a unit price of use based on the size of the moving body acquired by the reservation reception unit; and
the use fee determination unit is configured to determine the unit price of use as a confirmed unit price if the size of the moving body when the moving body enters the accommodation area is equal to or smaller than the size of the moving body acquired by the reservation reception unit.

4. The accommodation area management device according to claim 1, wherein
if the size of the moving body w % ben the moving body enters the accommodation area is larger than the size of the moving body acquired by the reservation reception unit, the entry determination unit is configured to permit the moving body to enter the accommodation area under a condition that there is an accommodation position capable of accommodating the moving body.

5. The accommodation area management device according to claim 4, further comprising:
a use fee determination unit configured to determine a use fee of the accommodation area, wherein:
the use fee determination unit is configured to acquire a unit price of use based on the size of the moving body acquired by the reservation reception unit; and
the use fee determination unit is configured to determine a fee equal to or greater than the unit price of use as a confirmed unit price if the size of the moving body when the moving body enters the accommodation area is larger than the size of the moving body acquired by the reservation reception unit.

6. The accommodation area management device according to claim 1, further comprising:
a use fee determination unit configured to determine a use fee of the accommodation area, wherein:
the entry determination unit is configured to request a user of the moving body to input the size of the moving body when the moving body enters the accommodation area; and
the use fee determination unit is configured to provide the user with the unit price of use acquired based on the size of the moving body.

7. The accommodation area management device according to claim 1, wherein
if the size of the moving body when the moving body enters the accommodation area is larger than the size of the moving body acquired by the reservation reception unit, and there is no accommodation position capable of accommodating the moving body, the entry determination unit is configured not to permit the moving body to enter the accommodation area.

8. The accommodation area management device according to claim 7, wherein
when the moving body is not permitted to enter the accommodation area, the entry determination unit is configured to provide a user of the moving body with accommodation area information on another accommodation area including an accommodation position capable of accommodating the moving body.

9. The accommodation area management device according to claim 1, wherein:
the accommodation area includes a boarding area for allowing the user of the moving body to get on and off; and
the accommodation area is an automatic valet parking type accommodation area where the moving body is automatically driven at least between the boarding area and the accommodation position for accommodating the moving body.
